(19) United States
(12) Patent Application Publication
(10) Pub. No.: US 2014/0144517 A1
(43) Pub. Date: May 29, 2014

(54) RAIL PLASMA ACTUATOR FOR HIGH-AUTHORITY FLOW CONTROL

(71) Applicant: Board of Regents, The University of Texas System, Austin, TX (US)

(72) Inventors: Laxminarayan RAJA, Austin, TX (US); Jayant SIROHI, Austin, TX (US); Mark CRAWFORD, Los Alamos, NM (US); Francesco STEFANI, Austin, TX (US)

(73) Assignee: Board of Regents, The University of Texas System, Austin, TX (US)

(21) Appl. No.: 13/962,721

(22) Filed: Aug. 8, 2013

Related U.S. Application Data
(60) Provisional application No. 61/730,157, filed on Nov. 27, 2012.

(51) Int. Cl. H05H 1/48

(52) U.S. Cl. CPC H05H 1/48
USPC 137/13; 422/186.21

(57) ABSTRACT

Apparatus and methods for forming and propagating a plurality of plasma armatures along electrodes. In particular embodiments, the electrodes are flush mounted to the surface and the plasma armatures are formed and propagated at a high frequency and velocity.

### CROSS-REFERENCE TO RELATED APPLICATIONS

This application claims priority to U.S. Provisional Patent Application Ser. No. 61/730,157 filed Nov. 27, 2012, which is incorporated by reference herein.

### BACKGROUND INFORMATION

Flow control devices are utilized in many applications that involve fluid flows inside of objects and external to objects. For example, in aerospace applications involving air flow over airplanes, helicopters, and rockets, air flow control is essential to maintaining flight stability and the trajectory of flight. Active control of the air flow is achieved through use of movable flaps, slats, and other blowing and suction devices. The bandwidth (or response times) of these mechanical flow control devices is however limited, and there is a need for flow control devices with much higher bandwidth and faster response times. Moreover, there is need for flow control devices that do not involve moving parts and are minimally intrusive to the surface structure on which they are mounted.

In contrast to mechanical devices, plasma flow control devices have no moving parts and offer very high bandwidths (for example, microsecond response times). In principle, plasma flow control devices offer a lightweight, easy to maintain flow control solution with minimal moving components. There are several competing plasma flow control technologies for aerodynamic flow control. These include Dielectric Barrier Discharge (DBD) driven by alternating current or nanosecond pulsed excitation, localized arc filaments, and pulsed plasma jets driven by localized arcs in cavities embedded within surfaces. Most existing technologies for atmospheric-pressure flow control applications such as DBD suffer from very poor aerodynamic flow actuation authority, with induced velocities not exceeding a few m/s. Consequently, the momentum transferred to the flow by the actuators is too small to be useful for most aerodynamic flow control applications. Cavity-driven localized arc pulsed plasma jets can produce high momentum fluxes normal to or at an off normal angle to the surface. However, these devices suffer structural issues due to cavity penetration within surfaces and localized hot-spots within the cavity.

### SUMMARY

Exemplary embodiments of the present disclosure address the issues encountered with competing plasma flow control technologies. As explained more fully below, in one exemplary embodiment the actuator is a simple device without moving parts. In a specific embodiment, the electrode rails can be flush mounted on a surface with minimal penetration into the solid surface, thereby avoiding any structural issues or disruptions to the surface aerodynamics. In addition, exemplary embodiments comprise a plasma armature that moves rapidly along the rails and reduces the likelihood of developing localized thermal hotspots on the surface. Furthermore, exemplary embodiments do not require external magnetic fields to propagate the plasma armature, contributing to the simplicity of the device. In specific exemplary embodiments, the plasma armature velocity can be very high (e.g., approximately 100 m/s), and the induced gas flow velocity can be commensurately high. This can provide high momentum fluxes imparted to the flow.

Exemplary embodiments may incorporate similar physical principles as a plasma armature railgun. However, in plasma armature railguns, the electrodes or rails are completely enclosed by insulators so that the armature is accelerated down a closed channel. In the exemplary embodiments of the present disclosure, the electrodes are flush with a surface rather than being enclosed.

The principal problem of very low flow actuation authority suffered by existing plasma flow actuator technologies is addressed by exemplary embodiments of the present disclosure. Significantly high aerodynamic and gas flow momentum fluxes can be realized by exemplary embodiments as compared to existing technologies.

There are a number of examples where exemplary embodiments of the present disclosure can play an important technological role. For example, certain embodiments can be used on aircraft wing surfaces to prevent flow separation under high angle of attack aircraft maneuvers. Other embodiments can be used within closed ducted surfaces, such as in gas turbine engines, to prevent flow separation at bends thereby reducing duct pressure losses. Still other embodiments can be located on gas turbine blades to prevent tip leakage losses. Additional embodiments can be used in helicopter applications to overcome retreating blade stall, increase maneuverability and improve hover performance.

Certain embodiments can also be used to improve blade root aerodynamics and to achieve active flow control on wind turbines. In addition exemplary embodiments with sufficiently high flow actuation authority can potentially be used as primary propulsion for neutrally buoyant flying vehicles such as blimps.

Exemplary embodiments of the present disclosure include a gas (aerodynamic) flow control device that can be used to control the fluid mechanical properties of gases (e.g., air) as they flow over solid surfaces. Exemplary embodiments may include a conductive pair of “rail”-type electrodes flush mounted on a surface over which the flow occurs.

Application of an electric potential difference across the electrodes induces breakdown of the gas at a predetermined end of the rails, which results in formation of a plasma armature (arc) that propagates down the rails as a consequence of self-induced magnetic fields that produce Lorentz forces on the plasma armature. In exemplary embodiments, the plasma armature entrains and pushes the surrounding gas as it propagates down the rails. The overall effect of the plasma armature motion is the induction of a fast moving wall jet of the gas over the surface.

In exemplary embodiments, the plasma armature formation and propagation down the rails can be repeated in rapid succession to form a quasi-continuous wall jet. Exemplary embodiments can comprise an array of individually addressable electrodes that can cover part or all of the area of the surface over which gas flow control is desired. In exemplary embodiments, the path of the electrode pair can be contoured over the surface area to induce gas flow wall jets in desired directions over the surface. The plasma armature can be initiated at the opposite end of the rails to induce gas flow in the opposite direction in exemplary embodiments. In addition an external magnetic field can be supplied by surface embedded permanent magnets or the use of an extra current wire loop under the rails to enhance the magnetic fields in exemplary embodiments.

Certain embodiments may include an apparatus comprising: a surface configured to allow a gas to flow over the surface; a first electrode; a second electrode; and an electrical circuit comprising a voltage source. In particular embodiments, the electrical circuit may be configured to repeatedly apply a voltage across the first and second electrodes sufficient to induce formation of a plurality of plasma armatures that propagate along the first and second electrodes. In specific embodiments, during operation the plurality of plasma armatures form a wall jet that controls gas flow over the surface. In certain embodiments, the wall jet may be a quasi-continuous wall jet. In particular embodiments, the electrical circuit may be configured to control the voltage with microsecond response times. In specific embodiments, the electrical circuit may comprise a transformer and a rectifier electrically coupled to the voltage source. In certain embodiments, the electrical circuit may comprise an inductor and a diode electrically coupled to the voltage source. In certain embodiments, the voltage source may be configured to provide a voltage of approximately three hundred volts to the electrical circuit.

In certain embodiments, the first and second electrode may comprise a protuberance configured to provide a location for initiation of a plasma armature. Particular embodiments may also comprise a third electrode coupled to the second electrode where the third electrode is separated from the first electrode by a dielectric layer. In specific embodiments, during operation a dielectric barrier discharge may form between the first and third electrodes. In particular embodiments, the dielectric barrier discharge may create an ionized air channel between the first and second electrodes and initiates a plasma armature. In certain embodiments, the surface may be an airfoil. In particular embodiments the first and second electrodes may be configured to mitigate the formation of vortices proximal to an end of the airfoil.

Certain embodiments may include an apparatus comprising: a surface configured to allow a gas to flow over the surface; a first electrode comprising a first end and a second end; a second electrode comprising a first end and a second end; and an electrical circuit comprising a voltage source. In particular embodiments, the first electrode and the second electrode may be flush-mounted on the surface; and the electrical circuit may be configured to apply a voltage across the first and second electrodes sufficient to induce a formation of a first plasma armature that propagates along the first and second electrodes. In certain embodiments, the first plasma armature may propagate toward the first end of the first and second electrodes. In particular embodiments, the first plasma armature may propagate toward the second end of the first and second electrodes. In specific embodiments, the first plasma armature may propagate along the first and second electrodes at a supersonic velocity. In certain embodiments, the first plasma armature may propagate from a first end of the first and second electrodes towards a second end of the first and second electrodes. In particular embodiments, the electrical circuit may be configured to control the voltage with microsecond response times. In certain embodiments, the electrical circuit may be configured to control the voltage at a frequency between 100 kHz and 1.0 MHz.

Particular embodiments may comprise a second electrode and a third electrode, where: the third electrode and the fourth electrode are flush-mounted on the surface; and the electrical circuit is configured to apply a voltage across the third and the fourth electrodes sufficient to induce a formation of a second plasma armature that propagates along the third and fourth electrodes. In certain embodiments, the first and second electrodes may be oriented in a first direction on the surface, and the second and third electrodes may be oriented in a second direction on the surface. In particular embodiments, the first direction may be generally perpendicular to the second direction. In specific embodiments, the surface may be an aircraft wing surface, an aircraft fuselage surface, a helicopter blade surface, a gas turbine blade surface, a wind turbine blade surface, or an air duct surface. In certain embodiments, the surface may be a neutrally buoyant vehicle surface. In particular embodiments, the surface may comprise an embedded permanent magnet. In specific embodiments, the surface may comprise a plurality of embedded wire loops.

Particular embodiments may include a method of controlling a flow of a gas over a surface, where the method comprises: applying a voltage at a frequency across a first electrode and a second electrode mounted on the surface; forming a plurality of plasma armatures that propagate along the first and second electrodes, such that the plurality of plasma armatures form a wall jet; and controlling the flow of the gas with the wall jet.

In certain embodiments, the first and second electrodes may be flush-mounted on the surface. In particular embodiments, the frequency may be between 100 kHz and 1 MHz. In certain embodiments, the plurality of plasma armatures may propagate along the first and second electrodes in a first direction. In certain embodiments, the plurality of plasma armatures may propagate along the first and second electrodes in a second direction that is opposite of the first direction.

In summary, exemplary embodiments of the present disclosure provide numerous benefits over existing technologies. For example, the device provides flush-mounted electrodes with little or no surface penetration of solid surface. In addition, exemplary embodiments comprise few or no moving components, and do not require external magnetic fields. Exemplary embodiments also do not create localized thermal hot-spots and provide for higher induced flow velocities (momentum fluxes) than current plasma flow actuation and control technologies.

In the present disclosure, the term “coupled” is defined as connected, although not necessarily directly, and not necessarily mechanically.

The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will be apparent to those skilled in the art from this detailed description.

### BRIEF DESCRIPTION OF THE FIGURES

FIG. 1 illustrates a schematic top view of an exemplary embodiment of an apparatus according to the present disclosure.

FIG. 2 illustrates a side view of the embodiment of FIG. 1.

FIG. 3 illustrates a schematic of an electrical circuit of the embodiment of FIG. 1.

FIG. 4 illustrates a schematic top view of an exemplary embodiment of an apparatus according to the present disclosure.

FIGS. 5A and 5B illustrate a schematic top and side view of an exemplary embodiment of an apparatus according to the present disclosure.

FIGS. 6A and 6B illustrate a schematic top and side view of an exemplary embodiment of an apparatus according to the present disclosure

FIG. 7 illustrates a schematic top view of an exemplary embodiment of an apparatus according to the present disclosure

FIG. 8 illustrates a schematic perspective view of an exemplary embodiment of an apparatus according to the present disclosure.

FIGS. 9 and 10 illustrate a test apparatus for testing an exemplary embodiment of an apparatus according to the present disclosure.

FIG. 11 illustrates a schematic of a test apparatus for testing an exemplary embodiment of an apparatus according to the present disclosure.

FIG. 12 illustrates a photo of high speed video of a test apparatus for testing an exemplary embodiment of an apparatus according to the present disclosure.

FIGS. 13-30 illustrate graphs of experimental data of an apparatus according to the present disclosure.

### DETAILED DESCRIPTION OF ILLUSTRATIVE EMBODIMENTS

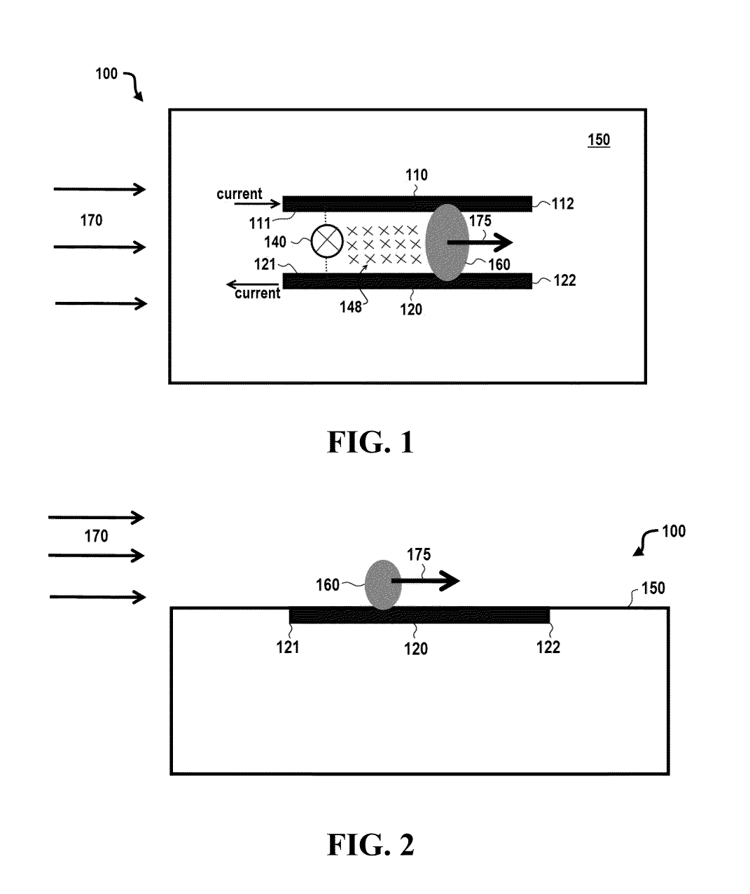

Referring now to FIGS. 1-3, an apparatus 100 comprises a surface 150 configured to allow a gas 170 to flow over the surface. In certain exemplary embodiments, surface 150 is a dielectric surface and may be configured, for example, as an aircraft wing or fuselage surface, a helicopter blade surface, a gas or wind turbine blade surface, an air duct surface, or a neutrally buoyant vehicle (e.g., blimp) surface. In specific embodiments, gas 170 may be air.

In this exemplary embodiment, apparatus 100 comprises a first electrode 110 and a second electrode 120 that are flush-mounted on surface 150. In the embodiment shown, first and second electrodes 110 and 120 are flush-mounted such that they do not disrupt the flow of gas 170 over surface 150. In specific embodiments, first and second electrodes 110 and 120 are formed by cutting grooves into surface 150 and placing first and second electrodes 110 and 120 in the grooves to realize a flush mounted (e.g., mechanically smooth) surface 150 for gas flow.

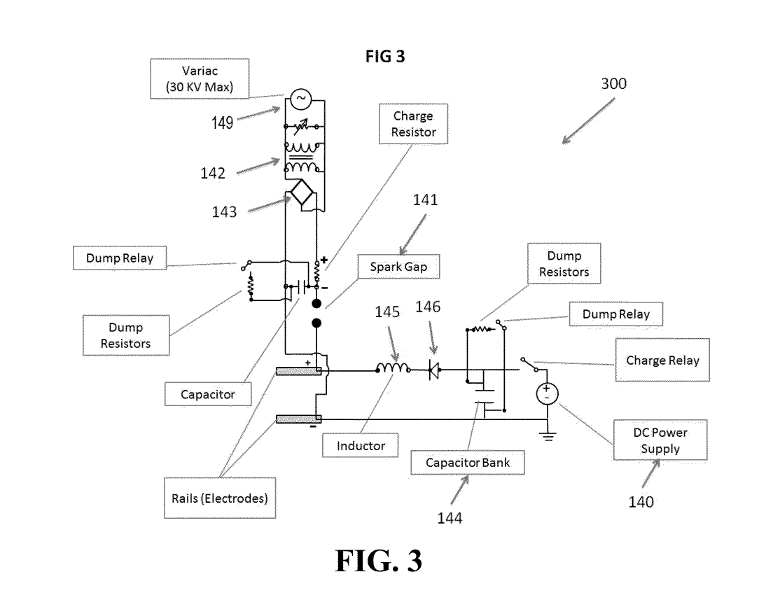

The exemplary embodiment shown also comprises a voltage source 140 configured to apply a voltage across first and second electrodes 110 and 120. In specific embodiments voltage source 140 can be configured as a low voltage (e.g., 250 volt) direct current (DC) power supply that is part of an electrical circuit 300. A schematic for one specific embodiment of such electrical circuit 300 is shown in FIG. 3. In exemplary embodiments, the breakdown of gas 170 provides the formation of an arc or plasma armature 160 that propagates along first and second electrodes 110 and 120, resulting from self-induced magnetic fields 148 that produce Lorentz forces on plasma armature 160. In particular embodiments, plasma armature 160 is propagated from a first end 111 of first electrode 110 and first end 121 of second electrode 120 towards a second end 112 of first electrode 110 and second end 122 of second electrode 120 (e.g. in the same direction as the flow of gas 170 over surface 150). In other embodiments, plasma armature 160 is propagated from a second end 112 of first electrode 110 and second end 122 of second electrode 120 towards a first end 111 of first electrode 110 and first end 121 of second electrode 120 (e.g. in the opposite direction as the flow of gas 170 over surface 150). During operation, plasma armature 160 can entrain and push the surrounding gas as it propagates along first and second electrodes 110 and 120.

In specific exemplary embodiments, plasma armature 160 is propagated at a high velocity along first and second electrodes 110 and 120, and voltage source 140 is configured to control the voltage applied across first and second electrodes 110 and 120 with microsecond response times. In specific exemplary embodiments, voltage source 140 is part of electric circuit 300 that can control the applied voltage with a rapid initiation time of a few microseconds, a single pulse duration of a few 100 microseconds and a pulse repetition frequency of 1 to 10's of Hz.

Accordingly, electrical circuit 300 can repeatedly provide for the formation and propagation of a plurality of plasma armatures 160 in rapid succession to control the fluid mechanical properties of gas 170 as it flows over surface 150. In certain embodiments, plasma armatures 160 can be propagated along first and second electrodes 110 and 120 to form a wall jet 175 of gas 170 over surface 150. In particular embodiments, plasma armature 160 can be rapidly and repeatedly formed and propagated along first and second electrodes 110 and 120 such that wall jet 175 is a quasi-continuous wall jet of gas 170.

During operation apparatus 100 can repetitively fire the plasma armatures 160 and initiate the plasma armatures 160 at a specific location along first and second electrodes 110 and 120. In a specific embodiment, first electrode 110 can be maintained as a “hot” electrode by keeping it coupled to voltage source 140. In particular embodiments, an AC power supply 149 and a transformer 142 in conjunction with a rectifier 143 can be used to create a high DC that is higher than the breakdown voltage of the air between first and second electrodes 110 and 120 at atmospheric pressure.

In specific embodiments, a spark gap 141 (with a gap that is slightly larger than the distance between first and second electrodes 110 and 120) can be connected in series between the first electrode 110 and the rectifier. During operation, the high DC voltage can initiate a spark across spark gap 141 which then creates a high voltage across first and second electrodes 110 and 120. With the gap between first and second electrodes 110 and 120 less than the spark gap, a plasma armature 160 can then be initiated across first and second electrodes 110 and 120. This can act as a trigger mechanism that allows for an initial high-voltage pulse that induces the electrical breakdown of the gas, followed by a lower voltage that sustains the armature (arc). The low voltage from voltage source 140 allows for large currents that may be necessary for armature sustenance and propagation down electrodes 110 and 120.

During operation of specific embodiments, a large current then flows through this ionized air channel, sustained by voltage source 140 and a capacitor bank 144 in parallel with voltage source 140, creating and propagating plasma armature 160. In exemplary embodiments, spark gap 141 prevents voltage source 140 from discharging through transformer 142. In addition, certain embodiments incorporate an inductor 145 to tailor the variation of the plasma current over time and a diode 146 to prevent the high voltage DC discharge from appearing across the electrodes of the low voltage capacitor. Specific embodiments incorporate a resistor-capacitor combination across the rectifier to create a periodic discharge of the high voltage, resulting in periodic firing of the plasma armatures 160.

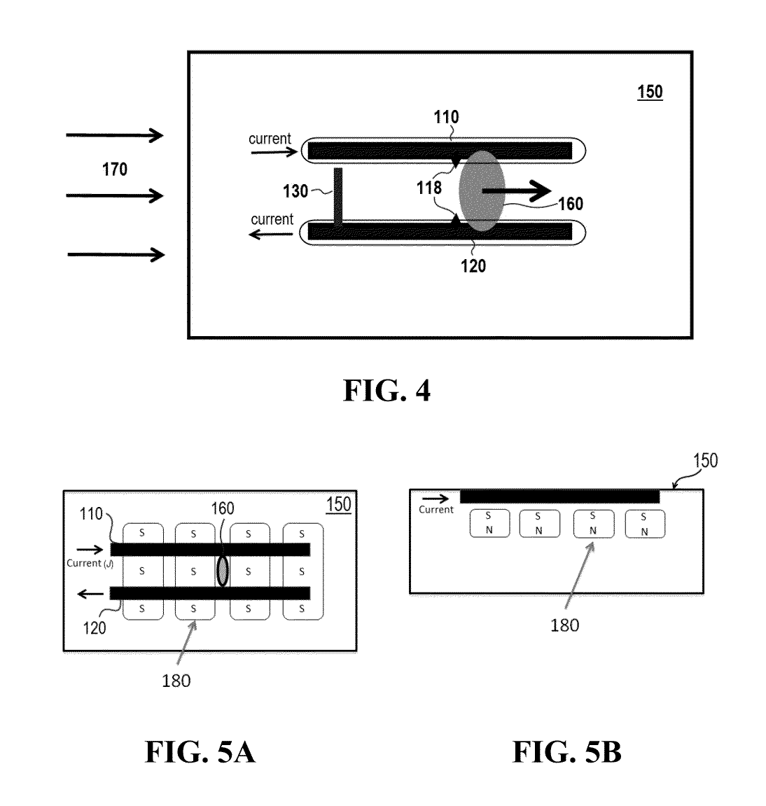

Referring now to FIG. 4, in particular embodiments, plasma armatures 160 can be initiated at a specific location with the incorporation of additional features. In certain embodiments, the location can be determined by the providing a small decrease in the air gap between first and second electrodes 110 and 120. In specific embodiments, the decrease in air gap can be provided by sharp wedges or protuberances 118 on first and second electrodes 110 and 120.

In particular embodiments, the initiation location of plasma armatures 160 can be determined by embedding a conducting extension 130 of one of the electrodes (e.g. the “grounded” electrode 120) such that this extension partly bridges the gap between the first and the second electrode under the dielectric surface 150, without making contact with the first electrode 110. In such embodiments, the first electrode 110 (e.g., the “hot” electrode) can be separated from the electrode extension 130 by a thin dielectric separation. During operation, a dielectric barrier discharge then forms between first electrode 110 and electrode extension 130, creating an ionized air channel above the surface 150. This ionized channel then propagates along the dielectric surface 150, guided by the underlying extension 130 until it bridges the gap between the first electrode 110 and the second electrode 120, thus initiating the plasma armature 160.

Referring now to FIGS. 5A and 5B, in certain embodiments, surface 150 may also comprise a plurality of permanent magnets 180 embedded below first and second electrodes 110 and 120 to provide an external magnetic field and improve the effectiveness of apparatus 100. FIG. 5A provides a schematic top view, while FIG. 5B provides a schematic side view. Magnets 180 can serve to enhance the magnetic field induced by the current (J) motion through first and second electrodes 110 and 120 and plasma armature 160. During operation of exemplary embodiments, the total magnetic field (B) is the sum of the field from the permanent magnets 180 and the induced magnetic field produced by current flow in first and second electrodes 110 and 120 and plasma armature 160. The net force on the plasma armature (J×B) is thereby enhanced.

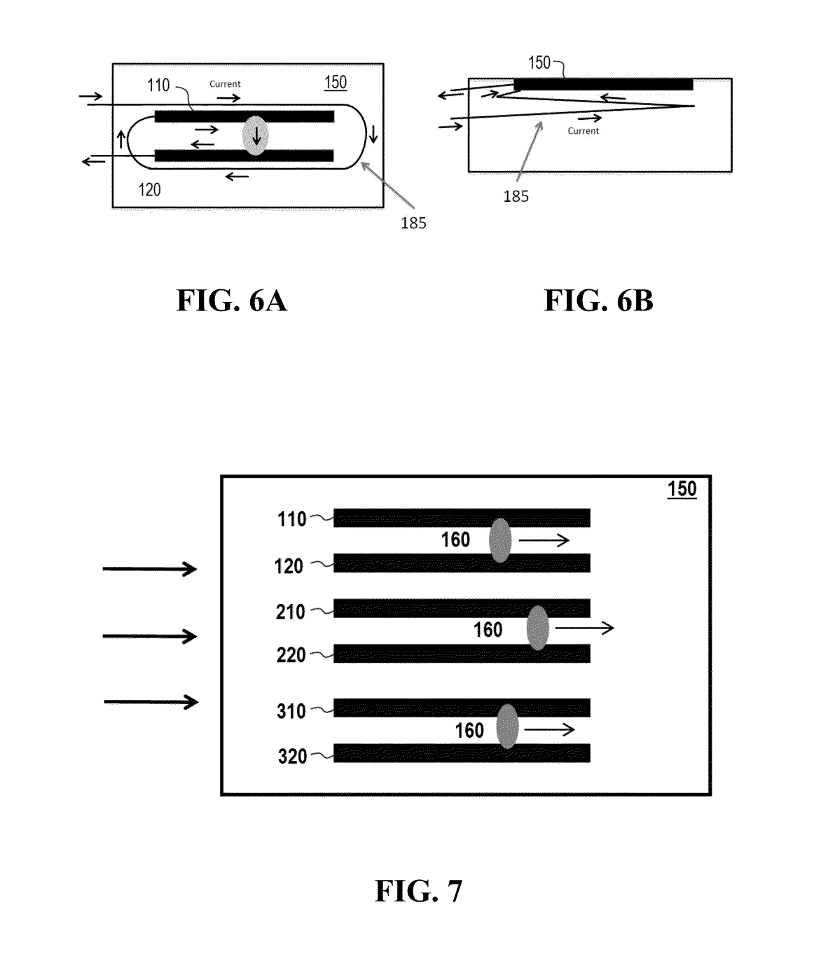

Referring now to FIGS. 6A and 6B, in still other embodiments, apparatus 150 may comprise a plurality of wire loops 185 embedded below first and second electrodes 110 and 120 in addition to, or in place of, permanent magnets 180 to enhance the magnetic field.

It is understood that other embodiments may not include all of the features shown and described in each of the figures. For example, certain embodiments may include one or more features such as protuberances 118, electrode extensions 130, wire loops 185 and permanent magnets 180.

Referring now to FIG. 7, in specific embodiments, surface 150 may comprise a plurality of electrodes (similar to electrodes 110 and 120). For example, surface 150 may comprise additional pairs of electrodes 210, 220 and 310, 320 that operate in a manner equivalent to electrodes 110 and 120 to generate a plurality of plasma armatures 160. In particular embodiments, a voltage source and electrical circuit can be configured to apply voltage across electrodes 210, 220 and 310, 320 while in other embodiments electrodes 210, 220 and 310, 320 may utilize a separate voltage source and electrical circuit.

Exemplary embodiments of apparatus 100 can also induce higher velocities of wall jet 175 and gas 170 as compared to other technologies, including for example, devices utilizing dielectric barrier discharge (DBD) technologies. By providing microsecond response times and repeated generation of plasma armature 160, apparatus 100 is capable of generating extremely high (e.g., potentially supersonic) velocities of plasma armature 160. Such velocities are capable of generating velocities of wall jet 175 that are sufficient to provide high momentum fluxes imparted and aerodynamic control of gas 170 as it flows over surface 150. In specific embodiments, velocities of wall jet 175 may be on the order of 100 m/s. In contrast, typical DBD actuators generate velocities on the order of a few meters per second.

In addition, the high velocity of plasma armature 160 along first and second electrodes 110 and 120 reduces the temperature increase of surface 150 and minimizes the likelihood that localized thermal hotspots will develop. Furthermore, in exemplary embodiments first and second electrodes 110 and 120 can be mounted on surface 150 with minimal penetration, which can minimize any structural effects on surface 150, as well as disruptions to surface aerodynamics.

Existing devices (including for example, those disclosed by Kalra et al. cited below) may comprise certain geometrical similarities to embodiments disclosed herein. However, the principles of operation of such devices are significantly different than embodiments of the present disclosure. For example, the Kalra device operates at very low pressures (approximately 30 Torr), with very low currents (approximately 100 mA) and is tailored for high-altitude high-speed flows (approximately Mach 3). The lack of high current densities in the discharge of the Kalra device imposes the requirement of a very high external magnetic field (approximately 5 Tesla), which is generated using a large solenoid coil. The external magnetic field is critical to the operation of Kalra device, while embodiments of the present disclosure require no external magnetic field for operation and operates at atmospheric pressure in open air.

Certain exemplary embodiments can be configured to provide gas (e.g., air) flow control in aerospace applications to improve aerodynamic performance and maintain flight stability for airplane, helicopter, or rocket applications. The lack of moving parts in apparatus 100 provides for improved response times as compared to mechanical flow control devices utilizing flaps, rudders, etc.

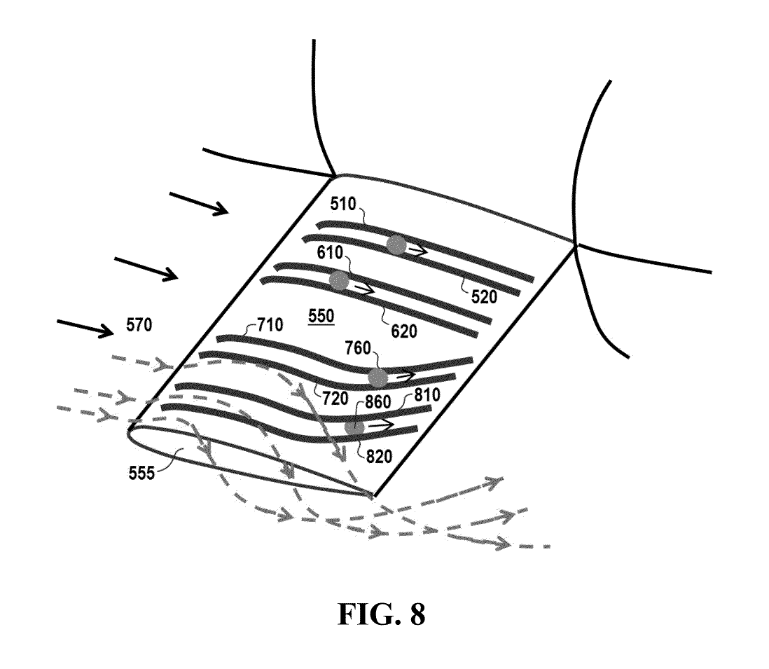

In certain embodiments, the electrodes may be oriented in different directions and can be contoured over a surface to induce plasma armatures and gas wall jets in various desired directions. Referring now to FIG. 8, electrode pairs 510, 520; 610, 620; 710, 720 and 810, 820 are oriented in multiple directions that can allow for the control of the flow of gas in multiple axes over a surface 550. In the embodiment shown, surface 550 is configured as the fixed or rotary wing surface of an aircraft or helicopter and the electrodes (e.g., electrodes 710, 720 and 810, 820 in particular) can be configured to counteract or mitigate vortex formation of airflow 570 near end 555 of surface 550. In specific embodiments, the electrodes can be used to generate plasma armatures 760 and 860 to reduce induced drag created by vortices 575 of airflow 570. The same principle can be used to mitigate tip leakage flow in the context of a gas turbine blade.

It is understood that electrodes illustrated in FIG. 6 are merely exemplary of numerous combinations that embodiments of the present disclosure may include. Other embodiments may include tens, hundreds or thousands of electrode pairs at various angles and configurations in order to provide precise gas flow control over a desired surface.

Experimental Data

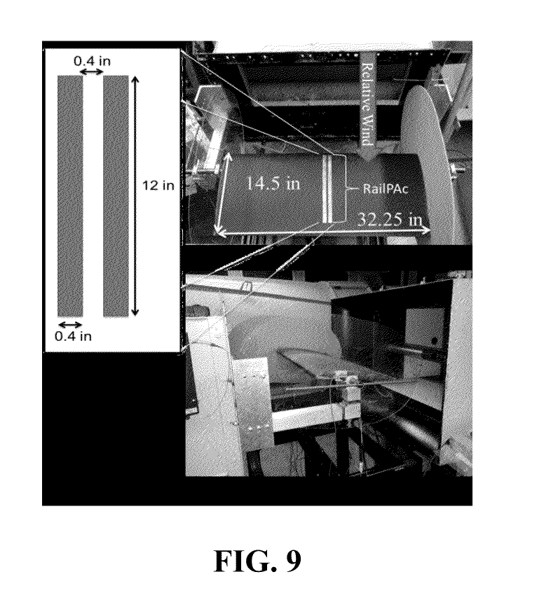

Wind tunnel tests were performed to evaluate the induced velocity profile of the electrodes (also referred to as a “RailPAc”) over an aerodynamic surface. A RailPAc is embedded in a two-dimensional wind tunnel test article (FIG. 9). The test article is a S5010 airfoil with a span of 32.25 inches and a chord of 14.5 inches. The RailPAc is comprised of two identical copper rail electrodes that are 0.4 inches wide and 12 inches long. The rails are flush mounted on a dielectric surface starting at 10% chord and separated by a gap of 0.4 inches. The plasma armature is initiated at the leading edge of the rails and travels in the chord-wise direction.

The copper rails conform to the airfoil profile without altering the shape or structural integrity and have a negligible weight penalty. When the actuators are not in use the rotor blade operates as a passive unaltered blade, because the rails are mounted smoothly on the surface of a rotor blade. Therefore, the addition of the RailPAc has no adverse effects on the performance of the rotor blade.

Plasma Armature Velocity Measurements

A Vision Research high-speed digital camera is used to capture video of the armature motion. The digital images are used to measure the velocity of the plasma armature and the spatial extent of the plasma armature. Top-down digital images of the plasma armature are acquired at a rate of 76,000 frames per second with a window size of 256×64 pixels. Frontal view images are acquired at a rate of 47,000 frames per second with a window size of 512×256 pixels. To increase the precision of the measurement the camera's aperture is placed at the minimum diaphragm opening, corresponding to an f-stop of 24, and a 10 mil. Mylar film lens is placed on the outside of the lens to act as a neutral-density filter. This procedure is conducted to eliminate the bright superheated air that surrounds the plasma armature. The exploding wire initiation pulse forming network is used for all high-speed imaging experiments and the wind tunnel experiments are conducted with the trigger circuit initiation pulse forming network.

Electrical Characteristics

All electrical signals are acquired and observed using a Tektronix 4 channel oscilloscope. The current is measured using a Powertek-Rogowski Current Waveform Transducer. The Rogowski Transducer is secured around the positive electrical lead between the pulse forming network and the positive rail. The transducer measures the rate at which the charge flows through the transducer coil with respect to time.

The voltage is measured using a differential voltage probe coupled to the breech of the rails with the electrical leads. The voltage probe records the voltage potential across the rails with respect to time.

Induced Flow Measurements

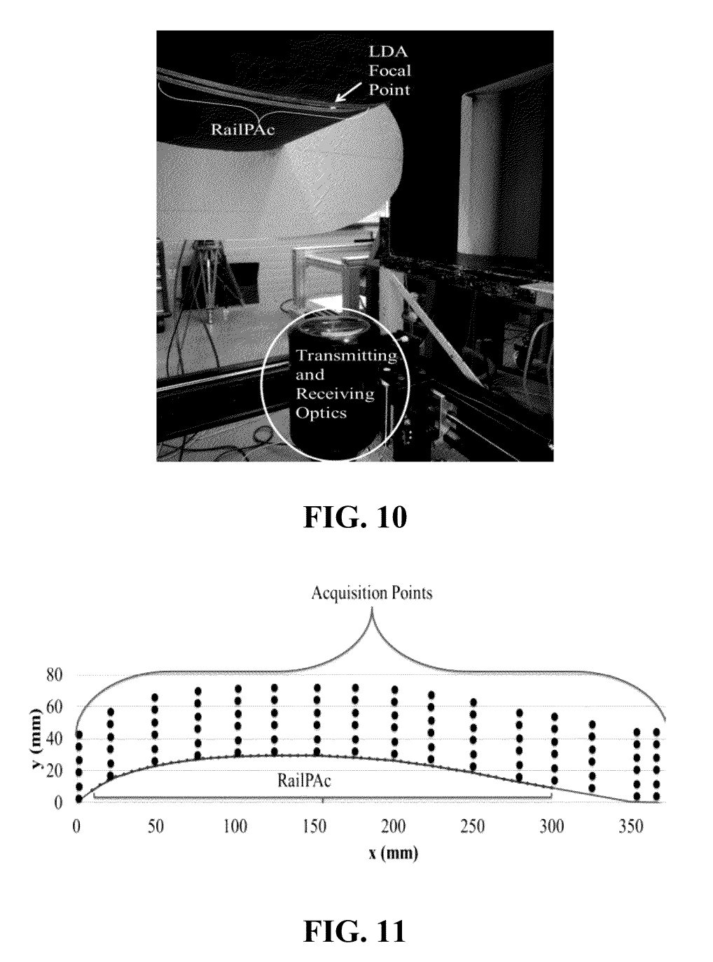

The wind tunnel test article is mounted in a sub-sonic open circuit wind tunnel and secured by two force balances in the lift and drag directions (FIG. 9 (b)). A Dantec Dynamics Laser Doppler Anemometer (LDA) is used to capture point-wise measurements of the flow velocity profile of the air immediately above the RailPAc at multiple free stream velocities. The LDA transmitting and receiving optics are mounted below the test article on a graduated mechanical traverse, capable of moving the sensing head in the chord-wise (x), span-wise (z), and normal (y) directions. Therefore, the test article is placed upside down in the wind tunnel (FIG. 10) at a zero degree angle of attack. A V_{c} of 250 V was used for all LDA experiments.

The focal point of the LDA is fixed in the center of the channel formed by the rails of the RailPAc and traverses in the chord-wise direction (x) from the leading edge to the trailing edge acquiring data every 25 mm. While stationary in the x direction the LDA is moved vertically (y) away from the surface of the airfoil to 45 mm above the airfoil surface. FIG. 11 shows the measurement grid. All results are presented with the airfoil correct side up.

Starting at the leading edge velocity measurements are acquired at 9 different locations in the y direction from the surface outward. The LDA measures the velocity of every seed particle that transitions through the focal point of the LDA. The seed particles are generated with a Rosco Fog Machine that seeds the wind tunnel with a dense water-based aerosol fluid. The LDA records the arrival time of the seed particle to the focal point and the transition time of the seed particle through the 1 mm beam width at the focal point. The individual velocities of seed particles flowing over the passive airfoil (RailPAc turned off) are calculated along with the mean velocity (Umean) of the seed particles captured during a 25 second sampling window. After the passive signal is stored the test is repeated at the same location with the RailPAc turned on. The RailPAc discharges 10 plasma armatures at a frequency of 1.25 Hertz (Hz) during the 25 second sampling window. The velocity signal with RailPAc on is compared to the passive signal by calculating the average of multiple velocity peaks produced by the RailPAc.

The open test section of the wind tunnel allows a large portion of the seed particles to escape reducing the fog density. Because the LDA operates on the random arrival time of the seed particles the sampling rate is random and at times very slow compared to the pulse duration of the armature. Due to the random sampling rate and the short interval of the plasma armature (approximately 2 ms) not all of the plasma armature transits are captured and recorded. Therefore, to properly analyze the results the LDA processor is linked to the pulse forming network through a common reference trigger system. Using the common reference trigger all velocity peaks in the LDA signal are directly correlated with the discharge of a plasma armature. Depending on the spatial location of the LDA focal point peak velocities occur every 2-9 ms after plasma armature discharge. The delay in the peak velocity is created by the 2.25 ms transition time of the plasma armature and the time it takes for the armature to transfer momentum to the surrounding flow.

Results and Discussion

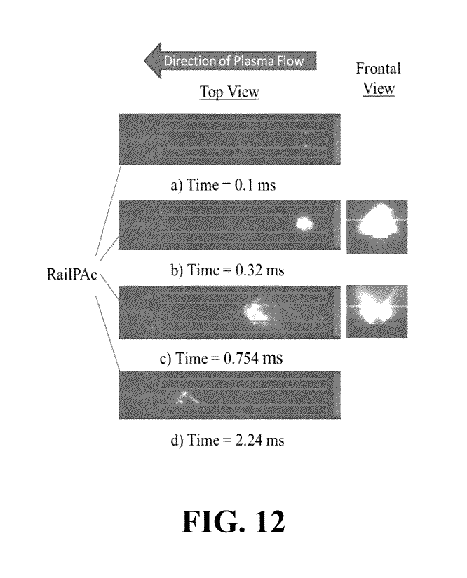

Filtered high-speed imaging is used to observe the relationship between capacitor charge voltage (V_{c}) and plasma armature velocity. FIG. 12 shows the high-speed imaging of the RailPAc discharge for an initial V_{c} of 250 V.

The filtered top-down view shows the plasma armature at quiescent atmospheric conditions from the initiation (FIG. 12 (a) at a time of 0.1 ms traversing from right to left maintaining consistent contact with the rails until 2.24 ms when the arc begins to extinguish (FIG. 12 (d)). Between the time of 0.32 ms and 0.754 ms the intensity of the armature has grown significantly, corresponding to a current of 1.75 kA and 3.25 kA, respectfully. The frontal view of the armature is also shown at a time of 0.32 ms and 0.754 ms. The frontal view shows that the area of the armature exceeds 1 square centimeter. The frontal view also shows that at 0.754 ms the plasma armature is traveling on top of the rails and is not localized between the rails. This allows the rails to be flush mounted on an airfoil and removes the need for the rails to be slightly elevated above the surface of the airfoil.

The high-speed video was used to calculate the transient velocity of the plasma armature by measuring the distance traveled between frames.

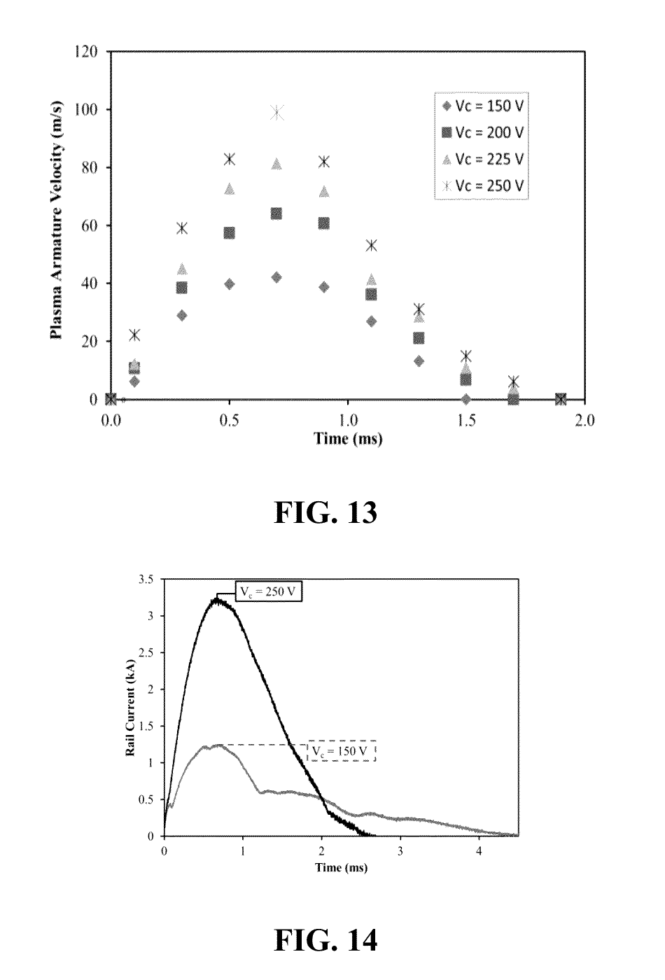

FIG. 13 is a plot of the plasma armature velocity with respect to time for four initial V_{c} values of 150 V, 200 V, 225 V, and 250 V. Following terminal velocity all four profiles decrease to a velocity of zero. The results of the plasma armature velocity measurements show that the velocity increases to a maximum of 100 meters per second (m/s) at 0.754 ms after initiation, and then decreases to zero for a V_{c} of 250 V.

The high-speed imaging was also used to qualitatively assess the flow field induced by the plasma armature motion. Six sets of Kevlar strings were placed 1 inch above the rails, spaced evenly from the point of initiation to 6 inches past the trailing-edge of the rails. The flow induced plasma armature was observed to deflect the tufts up to 90 degrees beyond their initial vertical position. This motion was found to persist up to 20 ms after the initiation of the armature motion.

Electrical Characteristics

The plasma armature current, J, rapidly increases from 0 A to ˜1 kA coinciding with an increase in the magnetic field, B. The Lorentz force (J×B) acting on the plasma armature reaches a maximum approximately 2.5 inches from the breech (FIG. 12 segment (c)). As the plasma armature reaches the muzzle the current diminishes and the armature decays. FIG. 14 depicts the transient values of the current through the rails for capacitor charge voltages of 150 V and 250 V.

The plasma armature current increases to a maximum peak value dependent on Vc. At a charge voltage of 250 V the peak current is 3.25 kA, while the peak current at a charge voltage of 150 V is 1.25 kA. The peak current values are reached at 0.754 ms for both cases. Following the peak value, the current diminishes to zero. All current peak values occur at 0.754 ms because the transient current is only a function of the capacitance and inductance of the pulse-forming network.

The frequency of the current through the plasma armature is defined as:

$$ω = \frac{1}{\sqrt{LC}}$$

The period of the plasma armature becomes:

T=\sqrt{LC}2π

Therefore, a constant inductance and capacitance yields a consistent armature pulse interval with a constant current peak time.

The plasma armature current transient, including the time of the peak current coincides with the plasma armature velocity transient in FIG. 13. An increase in Vc causes a rise in J resulting in a stronger B field, an increase in initial acceleration, and a higher terminal velocity. Therefore the velocity of the plasma armature is coupled to current through the Lorentz Force and the aerodynamic drag acting on the armature.

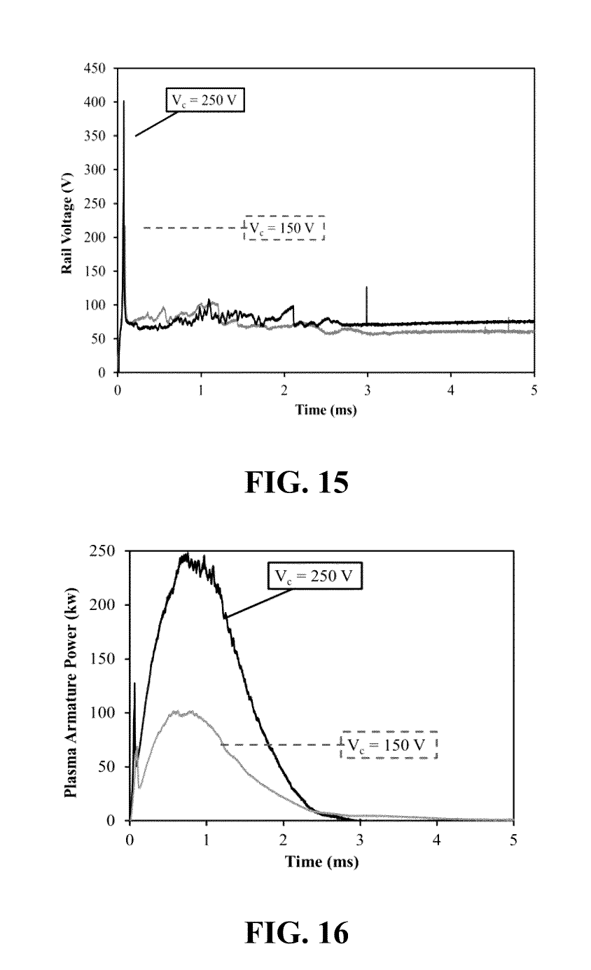

The voltage across the rails for a Vc of 150 V and 250 V can be viewed in FIG. 15. The voltage initially spikes due to the transient voltage rise across the inductor. With a Vc of 250 V a voltage spike of 400 V is observed and quickly dissipates to a steady state rail voltage of 80 V. For a Vc of 150 V the spike reaches a magnitude of 216 V and returns to a rail voltage of 60 V. Following the transient spike the voltage fluctuates until approximately 3 ms. After the plasma armature has extinguished the pulse forming network and rails remain at the steady state voltage.

The plasma armature instantaneous electrical power is the product of the current through the rails and the rail voltage. FIG. 16 shows the plasma armature power for a Vc of 150 V and 250 V with respect to time.

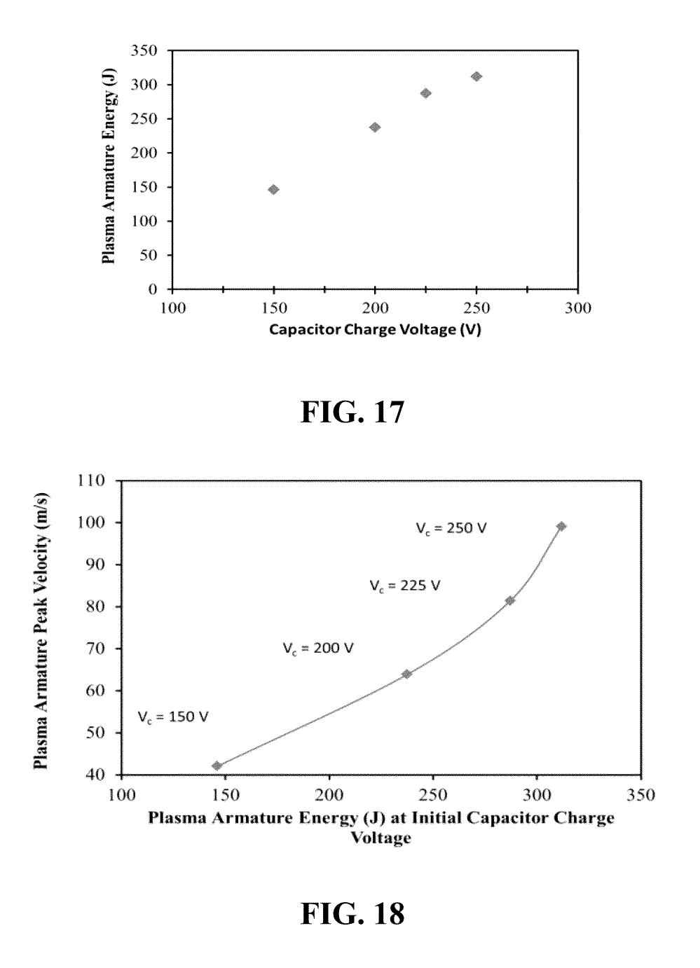

Due to the transient voltage spike through the inductor the power initially spikes to 123 kilowatts (kW) and 64 kW for a Vc of 150 V and 250 V, respectfully. The peak power of 248 kW, for a Vc of 250 V, and 99 kW, for a Vc of 150 V, occurs at 0.754 ms in direct correlation with the peak armature current and velocity. A time integration of the power in FIG. 16 results in a total energy of 312 Joules (J) and 146 J at a Vc of 250 V and 150 V, respectfully. FIG. 17 shows the relationship between capacitor charge voltage and energy consumed by the plasma armature per pulse.

The initial energy available in the capacitor bank is found using the following equation:

$${E}_{cap} = \frac{1}{2} {CV}_{c}^{3}$$

The stored energy in the capacitor bank is 236 J, 420 J, 532 J, and 656 J for the four initial Vc values. For the case of Vc equal to 250 V the energy available is 656 J and the energy consumed by the plasma armature is 312 J, 48% of the initial energy available in the capacitor bank. The voltage of the capacitor bank following the plasma discharge is 80 V resulting in an available energy value of 67 J. We can conclude that 30% to 40% of the initial capacitor energy is lost due to non-discharge related occurrences.

FIG. 18 shows the relationship between the peak velocity of the plasma armature at the initial Vc values of 150 V, 200 V, 225 V, and 250 V and the energy required to sustain the plasma armature at the given Vc values.

FIG. 18 shows that higher plasma armature peak velocities are achieved through greater initial stored energy in the capacitors. At the higher values of Vc an increase in plasma armature velocity is gained with reduced increases in initial capacitor charge energy.

This leads to improved performance of the plasma armature with minimal change to the input power. The increase in performance is attributed to the lower plasma armature resistance at higher values of Vc. For the four initial Vc values the plasma armature resistance is 67 milliohms (mΩ), 48 mΩ, 31 mΩ, and 24 mΩ. The reduction in plasma armature resistance at higher Vc values leads to a higher plasma armature velocity with a reduced increase in energy consumption.

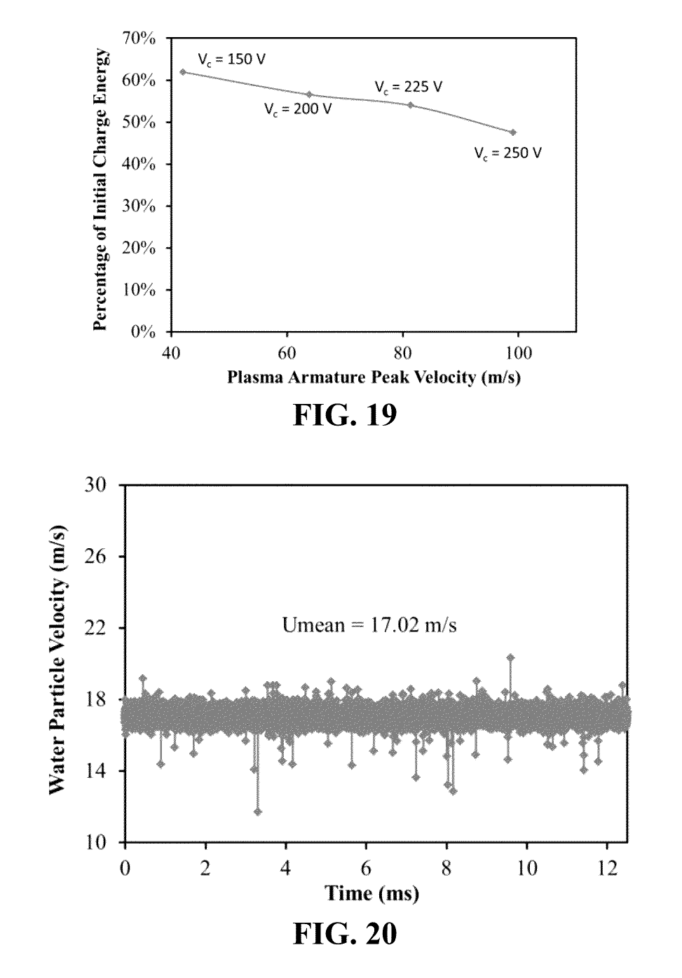

FIG. 19 displays the efficiency of the pulse forming network as a function of plasma armature peak velocity and Vc. At higher values of Vc the plasma armature achieves a higher peak velocity and consumes less of the initial energy available in the capacitor bank. With a Vc of 250 V the RailPAc uses 48% of the available capacitor bank energy to drive the plasma armature compared to 62% at a Vc of 150 V. Therefore, increasing the charge voltage not only improves the speed of the plasma armature, but improves the performance and efficiency of the plasma armature as well.

Induced Flow Measurements

FIG. 20 shows the LDA signal that is captured at a spatial position of 225.00 mm in the x direction and 27.84 mm in the y direction corresponding to the acquisition point 5 mm above the surface of the airfoil at 60% chord. The free stream velocity of the wind tunnel is 15.77 m/s with a resultant chord Reynolds number of 4.5×105. The signal in FIG. 20 represents the velocity of 32,000 seed particles that transit the focal point of the LDA. The passive (RailPAc turned off) mean velocity (Uₘₑₐₙ) of the seed particles is 17.02 mean, 0-m/s.

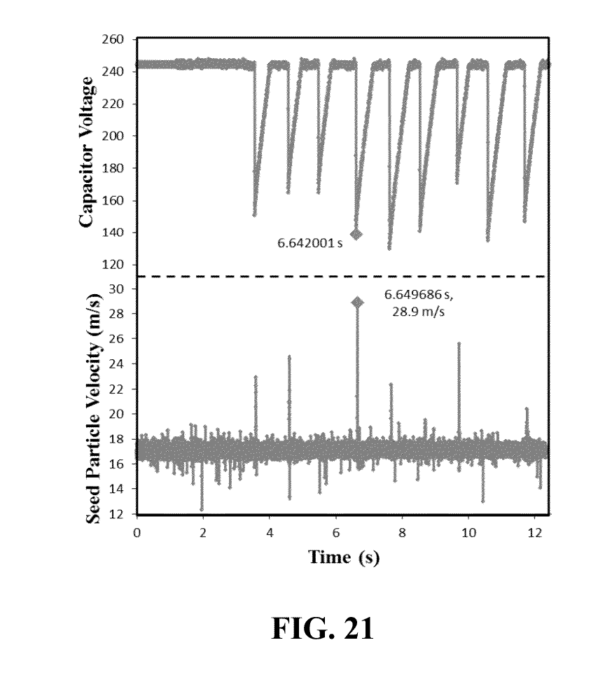

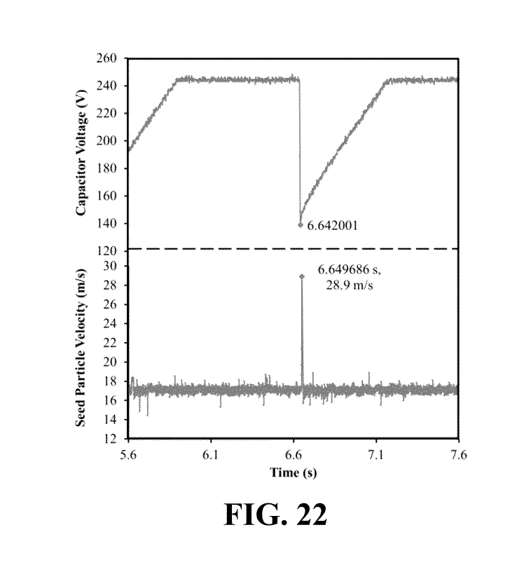

FIGS. 21 and 22 show the voltage signal from the capacitor bank and the velocity signal from the LDA. The sudden drop in voltage indicates the initiation of the plasma armature at the breech. The large spike in the LDA signal at 6.649 s is the result of the induced flow wall jet passing through the focal point of the LDA.

The analysis of the velocity peak in FIGS. 21 and 22, compared with the mean velocity in FIG. 20, shows that at 7.685 ms after the initiation of plasma armature there is an increase in the flow velocity from 17.02 m/s to 28.9 m/s 5 mm above the RailPAc and 225 mm aft of the leading edge (60% chord). The pulse forming network is designed to drive the plasma from the breech, located 37.25 mm aft of the leading edge (10% chord), along the rails to 223 mm aft of the leading edge (60% chord). The LDA spatial focal point was 2 mm aft of the plasma armature termination point. Given the time to travel the rails of 2.25 ms and the delay due to the entrainment effects, the induced flow created by the plasma armature on the neutral air reaches a maximum velocity at approximately 8 ms after plasma armature initiation, at this particular spatial location. FIG. 25 shows a zoomed in view of the velocity spike at 6.6496 ms.

It would appear that the large increase in seed particle velocity at 6.64 s is not consistent with all of the velocity peaks created by the plasma armature in the LDA signal in FIG. 21. This is a result of inefficient seeding of seed particles combined with the short pulse duration of the plasma armature. The open test section allows seed particles to escape at higher Reynolds numbers. The loss of seed particles over time coupled with the random sampling rate of the LDA leads to all or portions of the induced flow to go unrecorded. This is an inherent limitation of the LDA technique because it relies on the random arrival of the seed particles.

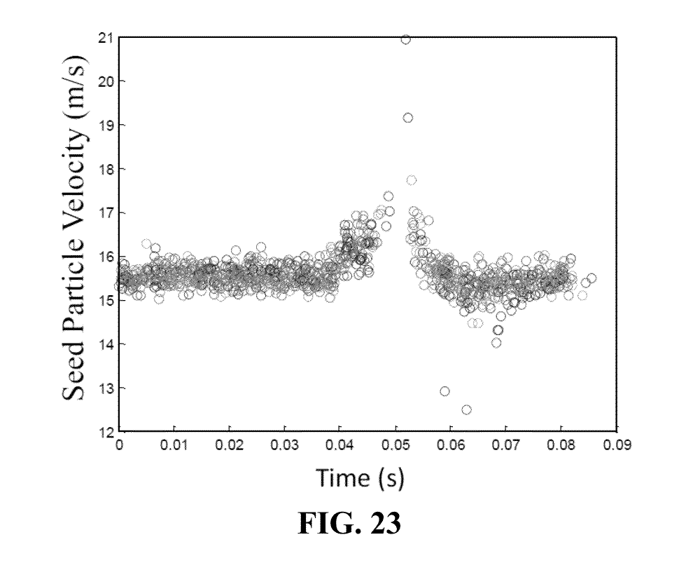

To find the mean seed particle velocity created by the plasma armature, the LDA velocity measurements are divided into individual velocity signals triggered by the capacitor discharge voltage signal. For nine capacitor bank discharges, with the LDA focal point stationary, nine individual velocity signals are extracted from the 12 second LDA signal in FIG. 21. The individual velocity signals are then synchronously averaged producing a mean velocity transient of the flow induced by the plasma armature discharge. FIG. 23 shows the nine separate velocity signals captured at a focal point of 275 mm aft of the leading edge and 10 mm above the surface of the airfoil. The individual signals are overlapped and the sampling window is reduced to 0.09 s.

An initial velocity transient due to the plasma armature is observed to begin at 0.04 s, coinciding with the formation of the plasma armature. Based on the transit time analysis of the plasma armature, the velocity increase at 0.04 s corresponds to compression at the leading edge of the plasma armature and the large velocity spike at 0.05 s corresponds to entrainment behind the plasma armature. This suggests that most of the induced velocity is due to entrainment, rather than compression in front of the plasma armature. Because the seed particles are randomly sampled, each of the transient velocity signals in FIG. 23 is resampled at a common sampling rate of 2500 Hz using linear interpolation. An optimal resampling frequency of 2500 Hz is determined by the sample density, i.e., by counting the number of samples within 1 sampling period at each resampled time. The resampled signals are synchronously averaged to find the weighted average induced velocity signal. The optimal criterion is one that maximizes the sample density with respect to the number of plasma armature discharges, while minimizing any sample windows that do not contain any seed particles.

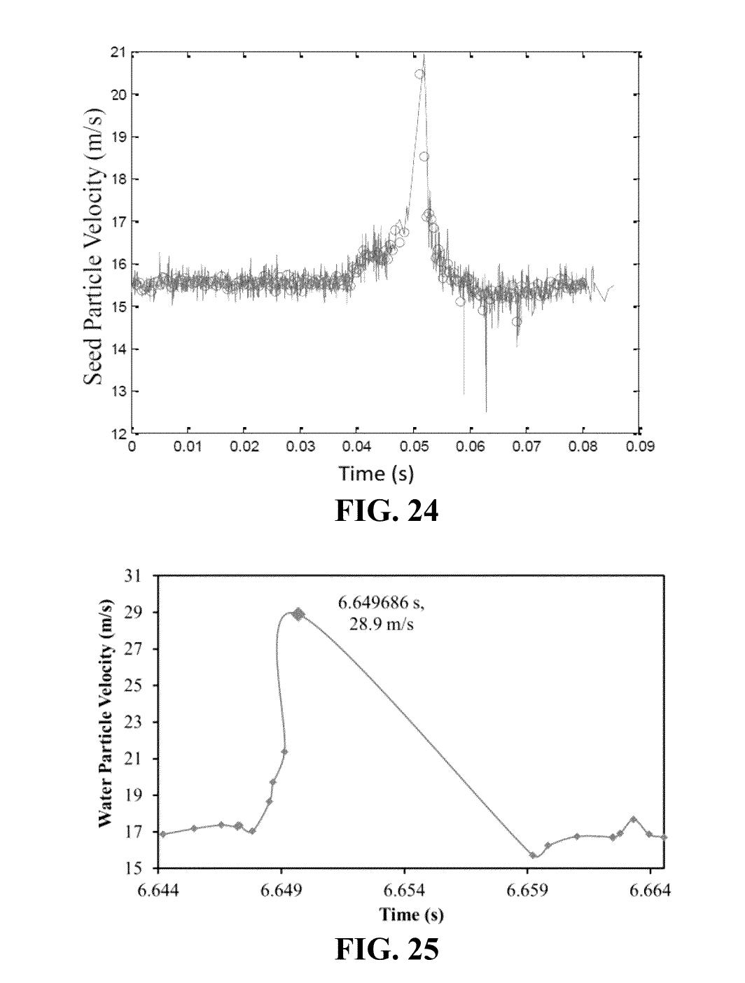

FIG. 24 shows the end result of the weighted synchronous average. From the mean velocity profile shown in FIG. 24 the peak induced velocity of all nine plasma armature discharges is seen to be around 20.5 m/s. Compared to the mean freestream velocity (FIG. 20), this indicates an average increase in the flow velocity from 17.02 m/s to 20.5 m/s at a location 10 mm above the RailPAc and 225 mm aft of the leading edge (−60% chord). Therefore, the plasma armature is capable of increasing the velocity of the airflow by an average of 5 m/s and the induced wall jet exists after the termination of the plasma armature. The maximum peak seed particle velocity is measured at all spatial locations indicated in FIG. 11.

Several measurements are acquired at each point and are synchronously averaged to yield the mean induced flow velocity transient; at a given chord-wise location, this yields the velocity profile of the induced flow. FIG. 20 displays the velocity profile of the induced flow created by the RailPAc compared to the velocity profile of the flow over the passive airfoil (RailPAc turned off). This data is captured at 75% chord (275 mm).

In FIG. 25 there is a rapid increase in the velocity of seed particles transitioning through the LDA focal point. Following the particle that was captured at 6.649686 s there is a 10 ms absence of seed particles due to the effects of the plasma armature on the neutral air flow. The Lorentz force accelerates the plasma armature as it travels chord-wise along the rails transferring momentum into the boundary layer. The air entrained behind the plasma armature pushes the seed particles away from the LDA focal point accounting for the 10 ms absence of seed particles. This is an inherent limitation of the LDA technique because it relies on the random arrival of the seed particles.

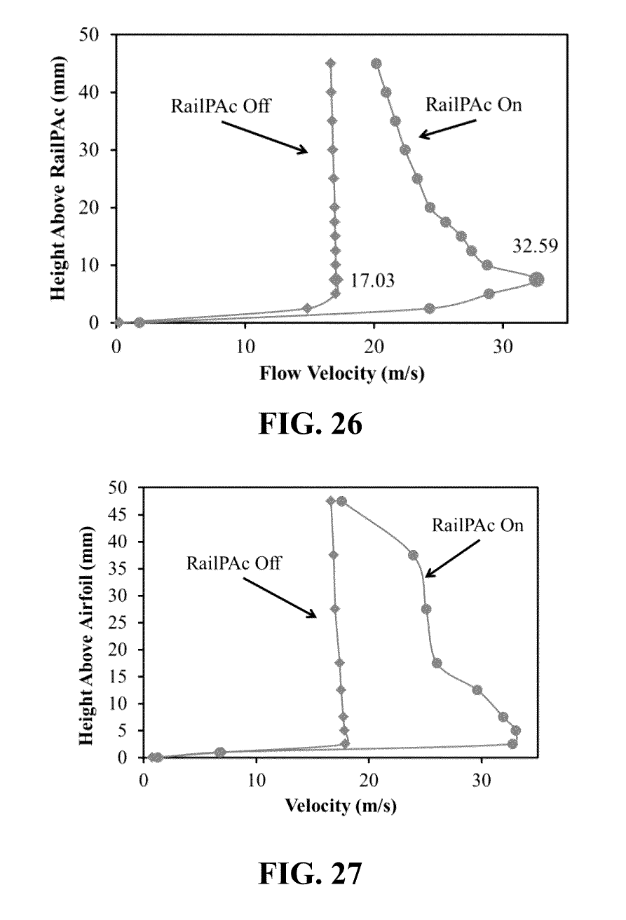

The maximum peak seed particle velocity is measured at all spatial locations indicated in FIG. 11. Several measurements are acquired at each point and these are averaged to yield the peak induced flow velocity. At a given chord-wise location, the peak induced flow velocity as a function of height from the airfoil surface yields the velocity profile of the induced flow. FIG. 26 displays the velocity profile of the induced flow created by the RailPAc compared to the velocity profile of the flow over the passive airfoil. This data is captured at 60% chord (225 mm) and approximately 7 ms after initiation of the plasma armature.

The RailPAc is observed to induce a wall jet with a peak induced flow velocity of 15.56 m/s above that of the free stream velocity. The location of the peak velocity is at 7.5 mm above the airfoil surface and the effect of the RailPAc induced flow velocity continues for 45 mm above the surface. These induced flow velocities are significantly higher than those obtained with DBD actuators and can further be increased with careful optimization of the rail geometry, pulse energy, and pulse duration. Also the RailPAc induces flow over a large volume of air, 8 times greater than the boundary layer thickness.

To provide a greater understanding of the RailPAc's control authority, velocity profile comparisons at chord-wise locations of 15%, 47%, and 80% chord are displayed in FIGS. 27, 28 and 29, respectively. At 15% chord (50 mm) the induced flow is greatest at 7.5 mm above the surface at 33.03 m/s, as shown in FIG. 27. The height of the induced flow is reduced at this location because the plasma armature has not fully developed.

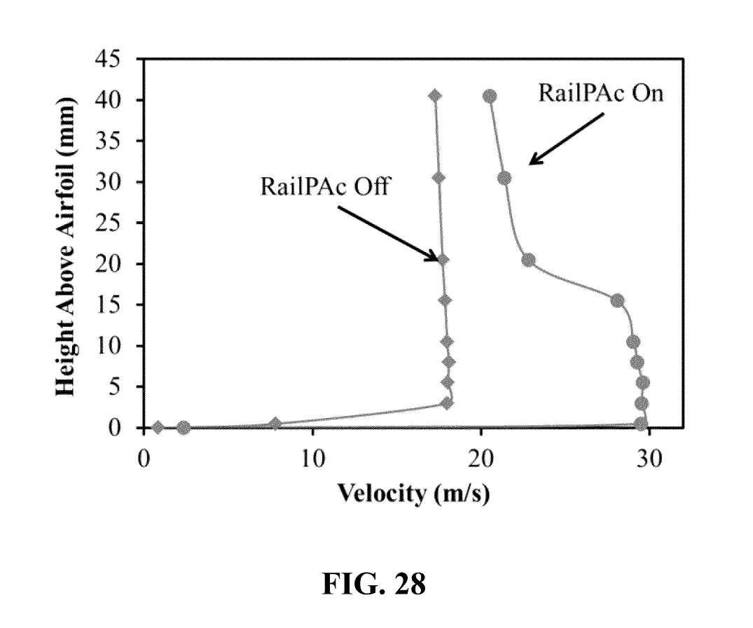

At 47% chord the induced flow wall jet effects have a maximum velocity of 29.58 m/s and the height of the wall jet extends to 15 mm above the surface of the RailPAc. The plasma armature is fully developed at 47% chord resulting in a taller wall jet, with respect to the airfoil surface, as shown in FIG. 28. At 47% chord the wall jet velocity created by the plasma armature is double that of the free stream velocity of 15.77 m/s.

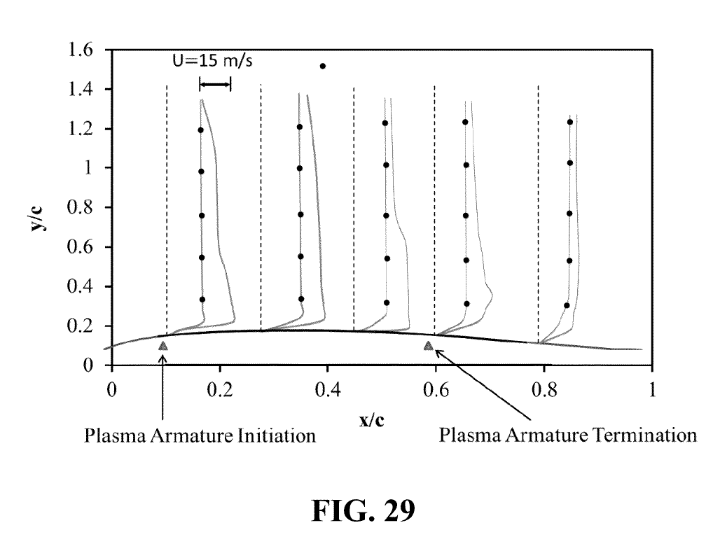

As the wall jet nears the trailing edge (80% chord) it begins to slow down because the plasma armature starts dissipating and the momentum transfer subsides. However, on average, the wall jet affected by the plasma armature is 5 m/s greater than the passive air flow over the airfoil as shown in FIG. 29. FIG. 29 illustrates a flow velocity comparison over the test article surface with and without RailPAc activation as a function of chord location. The first velocity profile (line with circular markers) in every group is the passive flow.

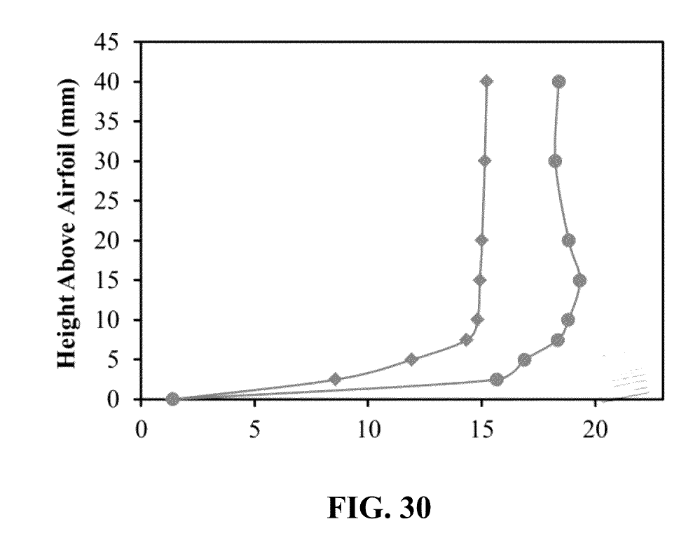

The results of the LDA velocity measurements is consolidated in FIG. 30, which shows the velocity profile created by the plasma armature compared to the passive flow velocities as a function of chord location. FIG. 30 illustrates a flow velocity comparison over the test article surface at 80% chord with and without RailPAc activation. From 15% chord to the trailing edge the plasma armature increases the velocity of the flow over the surface of the airfoil. From 15% to 60% chord the increase in flow velocities is 15 m/s or greater.

### CONCLUSIONS

A magnetohydrodyamic plasma actuator was experimentally tested in this work. The actuators called Rail Plasma Actuators or RailPAcs are comprised of a pair of rail electrodes that can be embedded in a rotor blade conformal to the airfoil profile, do not have any moving parts, require no structural modification of the rotor blade, and have a negligible weight penalty. A pulse forming network generates a low-voltage, high-current plasma armature that produces an induced wall jet. In conjunction with existing electrical slip rings and blade deicing heating mats, high currents can be achieved locally at the RailPAc using electronic circuitry to propagate a plasma armature. Most importantly, an electrical failure will have no adverse effects on the rotor, which will simply revert to a purely passive condition.

High-speed imaging of the plasma armature was conducted on a proof-of-concept bench-scale RailPAc in stagnant atmospheric air conditions to measure the velocity and electrical characteristics of the plasma armature. Results show that increasing the charge voltage of the capacitor bank led to an increase in the plasma armature peak velocity. For capacitor bank discharges with an energy output of approximately 100 J plasma armature velocities of approximately 100 m/s was observed in tranquil air. Laser Doppler Anemometer measurements of the induced flow resulted an induced flow wall jet velocity that was double the velocity of the free stream.

When placed in an sub-sonic open circuit wind tunnel at zero degrees angle of attack and a free stream velocity of 16 m/s the RailPAc demonstrated the propagation of an induced robust wall jet with peak velocities of 32 m/s. The RailPAc proved to induce velocities an order of magnitude greater than the velocities attained by electrohydrodynamic dielectric barrier discharge plasma actuators and provide the potential for alleviation of retreating blade stall. Future work will include experiments to gain a detailed understanding of the improvements to the static stall angle, the optimal actuator geometry, excitation duty cycle, and behavior of the plasma armature at high Mach/Reynolds number. Particle Image Velocimetry (PIV) will be utilized to improve the induced flow velocity measurements acquired with the LDA.

All of the devices, systems and/or methods disclosed and claimed herein can be made and executed without undue experimentation in light of the present disclosure. While the devices, systems and methods of this invention have been described in terms of particular embodiments, it will be apparent to those of skill in the art that variations may be applied to the devices, systems and/or methods in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

The contents of the following references are incorporated by reference herein:
C. S. Kalra, S. H. Zaidi, R. B. Miles and S. O. Macheret, “Shockwave-turbulent boundary layer interaction control using magnetically driven surface discharges,” Experiments in Fluids, Vol. 50, 2011, pp. 547-559.
Leishman, J. G., Principles of Helicopter Aerodynamics, Cambridge University Press, New York, N. Y. 2002, pp. 27, 380-381.
Can, L. W., and McAlister, K. W., “The Effect of a Leading Edge Slat on the Dynamic Stall of an Oscillating Airfoil,” Paper AIAA 83-2533, AIAA/AFS Aircraft Design, Systems, and Operations Meeting, Ft. Worth, Tex., October 1983.
Yu, Y. H., McAlister, K. W., Tung, C., and Wang, C. M., “Dynamic Stall Control for Advanced Rotorcraft Application,” AIAA Journal, Vol. 33, (2), February 1992, pp. 289-295.
Karim, M. A. and Achyara, M., “Control of the Dynamic Stall Vortex over a Pitching Airfoil by Leading Edge Suction,” Paper AIAA 93-3267, Shear Flow Conference, Orlando, Fla., July 1993.
Lorber, P., McCormick, D., Anderson, T., Wake, B., MacMartin, D., Pollack, M., Corke, T., Breuer, K., “Rotorcraft Retreating Blade Stall Control,” Paper AIAA 2000-2475, Fluids 2000 Conference and Exhibit, Denver, Colo., June 2000.
Yeo, H., “Assessment of Active Controls for Rotor Performance Enhancement,” Journal of the American Helicopter Society, Vol. 53, (2), April 2008, pp. 152-163.
Suzen, Y. B., and Huang, P. G., “Simulations of Flow Separation Control Using Plasma Actuators.” Paper AIAA 2006-877, Aerospace Sciences Meeting and Exhibit, Reno, Nev., January 2006.
Moreau, E., “Airflow Control by Non-Thermal Plasma Actuators,” Journal of Physics D: Applied Physics, Vol. 40, (3), 2007, pp. 605-636.
Post, M. L., and Corke, T. C., “Separation Control on a High Angle of Attack Airfoil Using Plasma Actuators,” AIAA Journal, Vol. 42, 11, 2004, pp. 2177-2184.
Santhanakrishnan, A., and Jacob, J. D., “Flow Control With Plasma Synthetic Jet Actuators,” Journal of Physics D: Applied Physics, Vol. 40, (3), 2007, pp. 637-651.
Post, M. L., and Corke, T. C., “Separation Control Using Plasma Actuators-Dynamic Stall Vortex Control on an Oscillating Airfoil,” AIAA Journal, Vol. 44, (12), 2006, pp. 3125-3135.
Nelson, R. C., Corke, T. C., and Othman, H., “A Smart Wind Turbine Blade Using Distributed Plasma Actuators for Improved Performance,” Paper AIAA 2008-1312, 46th Aerospace Sciences Meeting, Reno, Nev., January 2008.
Patel, M. P., Ng, T. T., Vasudevan S., Corke, T. C., and He, C., “Plasma Actuators for Hingeless Aerodynamic Control of an Unmanned Air Vehicle,” Journal of Aircraft, Vol. 44, (4), August 2007, pp. 1264-1274.
Patel, M. P., Ng, T. T., Vasudevan S., Corke, T. C., Post, M. L., McLaughlin, T. E., and Suchomel, C. F., “Scaling Effects of an Aerodynamic Actuator,” Journal of Aircraft, Vol. 45, (1), 2008, pp. 223-236.
Pai, S. T., and Zhang, Q., “Introduction to High Power Pulse Technology,” Advance Series in Electrical and Computer Engineering, Vol. 10, 1995, pp. 272-274 Kelkar, M., and Heberlein, J., “Physics of an Arc in Cross Flow,” Journal of Applied Physics, Vol. 33, 2000, pp. 2177.

1. An apparatus comprising:
a surface configured to allow a gas to flow over the surface;
a first electrode;
a second electrode; and
an electrical circuit comprising a voltage source, wherein:
the electrical circuit is configured to repeatedly apply a voltage across the first and second electrodes sufficient to induce formation of a plurality of plasma armatures that propagate along the first and second electrodes.

2. The apparatus of claim 1 wherein during operation the plurality of plasma armatures form a wall jet that controls gas flow over the surface.

3. The apparatus of claim 2 wherein the wall jet is a quasi-continuous wall jet.

4. The apparatus of claim 1 wherein the electrical circuit is configured to control the voltage with microsecond response times.

5. The apparatus of claim 1 wherein the electrical circuit comprises a transformer and a rectifier electrically coupled to the voltage source.

6. The apparatus of claim 1 wherein the electrical circuit comprises an inductor and a diode electrically coupled to the voltage source.

7. The apparatus of claim 1 wherein the voltage source is configured to provide a voltage of approximately three hundred volts to the electrical circuit.

8. The apparatus of claim 1 wherein the first and second electrode comprise a protuberance configured to provide a location for initiation of a plasma armature.

9. The apparatus of claim 1 further comprising a third electrode coupled to the second electrode wherein the third electrode is separated from the first electrode by a dielectric layer.

10. The apparatus of claim 9 wherein during operation a dielectric barrier discharge forms between the first and third electrodes.

11. The apparatus of claim 10 wherein the dielectric barrier discharge creates an ionized air channel between the first and second electrodes and initiates a plasma armature.

12. The apparatus of claim 1 wherein the surface is an airfoil.

13. The apparatus of claim 12 wherein the first and second electrodes are configured to mitigate the formation of vortices proximal to an end of the airfoil.

14. An apparatus comprising:
a surface configured to allow a gas to flow over the surface;
a first electrode comprising a first end and a second end;
a second electrode comprising a first end and a second end; and
an electrical circuit comprising a voltage source, wherein:
the first electrode and the second electrode are flush-mounted on the surface; and
the electrical circuit is configured to apply a voltage across the first and second electrodes sufficient to induce a formation of a first plasma armature that propagates along the first and second electrodes.

15. The apparatus of claim 14 wherein the first plasma armature propagates toward the first end of the first and second electrodes.

16. The apparatus of claim 14 wherein the first plasma armature propagates toward the second end of the first and second electrodes.

17. The apparatus of claim 14 wherein the first plasma armature propagates along the first and second electrodes at a supersonic velocity.

18. The apparatus of claim 14 wherein the first plasma armature propagates from a first end of the first and second electrodes towards a second end of the first and second electrodes.

19. The apparatus of claim 14 wherein the electrical circuit is configured to control the voltage with microsecond response times.

20. The apparatus of claim 14 wherein the electrical circuit is configured to control the voltage at a frequency between 100 kHz and 1.0 MHz.

21. The apparatus of claim 14, further comprising a second electrode and a third electrode, wherein:
the third electrode and the fourth electrode are flush-mounted on the surface; and
the electrical circuit is configured to apply a voltage across the third and the fourth electrodes sufficient to induce a formation of a second plasma armature that propagates along the third and fourth electrodes.

22. The apparatus of claim 21 wherein the first and second electrodes are oriented in a first direction on the surface and wherein the second and third electrodes are oriented in a second direction on the surface.

23. The apparatus of claim 21 wherein the first direction is generally perpendicular to the second direction.

24. The apparatus of claim 14 wherein the surface is an aircraft wing surface.

25. The apparatus of claim 14 wherein the surface is an aircraft fuselage surface.

26. The apparatus of claim 14 wherein the surface is a helicopter blade surface.

27. The apparatus of claim 14 wherein the surface is a gas turbine blade surface.

28. The apparatus of claim 14 wherein the surface is a wind turbine blade surface.

29. The apparatus of claim 14 wherein the surface is an air duct surface.

30. The apparatus of claim 14 wherein the surface is a neutrally buoyant vehicle surface.

31. The apparatus of claim 14 wherein the surface comprises an embedded permanent magnet.

32. The apparatus of claim 14 wherein the surface comprises a plurality of embedded wire loops.

33. A method of controlling a flow of a gas over a surface, the method comprising:
applying a voltage at a frequency across a first electrode and a second electrode mounted on the surface;
forming a plurality of plasma armatures that propagate along the first and second electrodes, such that the plurality of plasma armatures form a wall jet; and
controlling the flow of the gas with the wall jet.

34. The method of claim 33 wherein the first and second electrodes are flush-mounted on the surface.

35. The method of claim 33 wherein the frequency is between 100 kHz and 1 MHz.

36. The method of claim 33 wherein the plurality of plasma armatures propagate along the first and second electrodes in a first direction.

37. The method of claim 36 wherein the plurality of plasma armatures propagate along the first and second electrodes in a second direction that is opposite of the first direction.
